(19) United States
(12) Patent Application Publication
(10) Pub. No.: US 2006/0188597 A1
(43) Pub. Date: Aug. 24, 2006

(54) Injection drive mechanism for a servo injection molding machine

(76) Inventor: Vincent Chang, Pa Teh City (TW)

Correspondence Address: PRO-TECTOR INTERNATIONAL SERVICES, 20775 NORADA CT., SARATOGA, CA, 95070, US

(21) Appl. No.: 11/067,379

(22) Filed: Feb. 24, 2005

(51) Int. Cl. B29C 45/70

(52) U.S. Cl. 425/149; 425/150; 425/557

(57) ABSTRACT

A servo injection molding machine includes an injection screw, a ball screw, and a spline shaft that are mounted along the same axis. The ball screw includes an axial receptacle in an end thereof for receiving an end of the spline shaft. Thus, the ball screw is movable toward or away from the spline shaft along the axis. An injection motor drives the ball screw and the injection screw to move rectilinearly. A metering motor drives the spline shaft to rotate on site.

### BACKGROUND OF THE INVENTION

1. Field of the Invention

The present invention relates to an injection drive mechanism for a servo injection molding machine. In particular, the present invention relates to an injection drive mechanism including an injection screw, a ball screw, and a spline shaft that are mounted along the same axis.

2. Description of the Related Art

A typical injection molding machine is actuated by hydraulic control that has problems of considerable energy consumption, oil leakage, and slow response to speed control. A servo-controlled injection molding machine may obviate the above problems, yet it is very complicated, as different injection speed control, pressure maintaining, material feeding, backpressure, etc are involved. An injection molding machine must be capable of controlling ordinary-speed injection or high-speed injection, and in some cases must provide low-speed/high-pressure injection. When the molten plastic material enters a mold cavity, the temperature of the plastic material begins to lower and the plastic material begins to solidify and thus shrink. At this time, pressure maintaining is required, and plastic material is supplied into the mold cavity to obtain a product with a precisely formed shape. The plastic material that moves forward in a barrel is stirred (by rotational movement of an injection screw) and heated by frictional heat resulting from shear force in the barrel, thereby performing the feeding/melting procedure. Meanwhile, when the molten plastic material is piled up in the barrel for subsequent injection, the injection screw must be moved backward very slowly to perform the backpressure control procedure, which affects the quality of the product to be formed.

U.S. Pat. No. 5,129,808 discloses a two-plate type injection apparatus comprising a front plate, a pusher plate, and a single motor to drive two ball screws for actuating the pusher plate and a metering motor as well as corresponding feeding elements. Nevertheless, there are five axes involved, including two axes for two ball screws, two axes for two linear guides, and an axis for an injection screw. As a result, it is extremely difficult to keep the five axes parallel to each other. Making the ball screws, linear guides, and the injection screw move synchronously and controlling the precision are also difficult to achieve. In addition, such a servo-injection apparatus is heavy, consumes driving energy, and is incapable of performing high-speed injection.

U.S. Pat. No. 4,693,676 discloses a screw-rotating/injection mechanism of an injection molding machine, wherein the front base and rear base are stationary and the pressure plate is movable. A servomotor drives two ball screws for actuating the pressure plate to thereby move a screw shaft. The other servomotor drives the screw shaft to rotate for feeding. Such an injection mechanism still has the drawbacks of heavy weight, consumption of driving energy, difficulty in keep several active axes parallel to each other, and difficulty in achieving synchronous control.

U.S. Pat. No. 6,368,095 to the applicant of the present invention discloses an injection drive mechanism for a servo injection molding machine, wherein the injection drive mechanism includes an injection screw, a ball screw, and a spline shaft that are mounted along the same axis. Further, the injection drive mechanism includes an injection motor and a metering motor that may operate at various speeds and/or operate in the same direction or different direction for providing various injection operations. However, the ball screw is connected to the spline shaft via a connecting seat, and the injection motor must drive both of the ball screw and the spline shaft. In other words, the energy consumption could not be further reduced.

### SUMMARY OF THE INVENTION

An injection drive mechanism for a servo injection molding machine in accordance with the present invention comprises a base, a barrel, an injection screw, a ball screw, a spline shaft, an injection motor, and a metering motor. The base has a barrel seat, an injection seat, and a feeding seat mounted thereon. The base includes a feeding inlet.

The barrel is mounted to the barrel seat. The injection screw is rotatably extended through the barrel. The feeding inlet allows feeding of plastic material to the injection screw. The ball screw is mounted to the injection seat and includes a first end that is connected with the injection screw and a second end having an axial receptacle. The ball screw includes an axis that is coincident with that of the injection screw.

A spline nut is mounted in the axial receptacle of the ball screw. The spline shaft is rotatably supported by the feeding seat. The spline shaft has an axis coincident with that of the ball screw. The spline shaft includes an end coupled with the spline nut such that the spline shaft and the ball screw rotate jointly about the axis and that the spline shaft is not driven to move rectilinearly along the axis when the ball screw moves rectilinearly along the axis.

The injection motor drives the ball screw to move relative to the spline shaft along the axis. The metering motor drives the spline shaft to rotate on site.

Since the spline shaft is not moved rectilinearly when the ball screw moves rectilinearly along the axis, the energy required for driving the ball screw to move rectilinearly along the axis is relatively small as compared to that required in the conventional design.

Preferably, a ball nut is mounted around the ball screw. A sleeve is securely mounted around the ball nut. A deep groove bearing and a thrust bearing are mounted between the sleeve and the injection seat.

Preferably, a pressure sensor is mounted to the injection seat and adjacent to the thrust bearing. Preferably, the pressure sensor includes an inner and an outer ring that is integrally formed with the inner ring. The outer ring is fixed to the injection seat. The inner ring abuts against the thrust bearing for detecting pressure fed back by plastic material in the barrel.

Preferably, a sleeve is fixed to the other end of the spline shaft, and two deep groove bearings are mounted between the feeding seat and the sleeve fixed to the spline shaft. A pulley is fixed to the sleeve to turn therewith. The pulley is driven by the metering motor. A spline nut is mounted between the other end of the spline shaft and the sleeve. The pulley includes a central hole, and the sleeve includes a central hole in an end face thereof. A bolt is extended through the central hole of the pulley and the central hole of the sleeve into the spline shaft.

Other objectives, advantages, and novel features of the invention will become more apparent from the following detailed description when taken in conjunction with the accompanying drawings.

### BRIEF DESCRIPTION OF THE DRAWINGS

FIG. 1 is a sectional view of an injection drive mechanism for a servo injection molding machine in accordance with the present invention, wherein the ball screw is moved forward.

FIG. 2 is a sectional view similar to FIG. 1, wherein the ball screw is moved backward.

### DETAILED DESCRIPTION OF THE PREFERRED EMBODIMENT

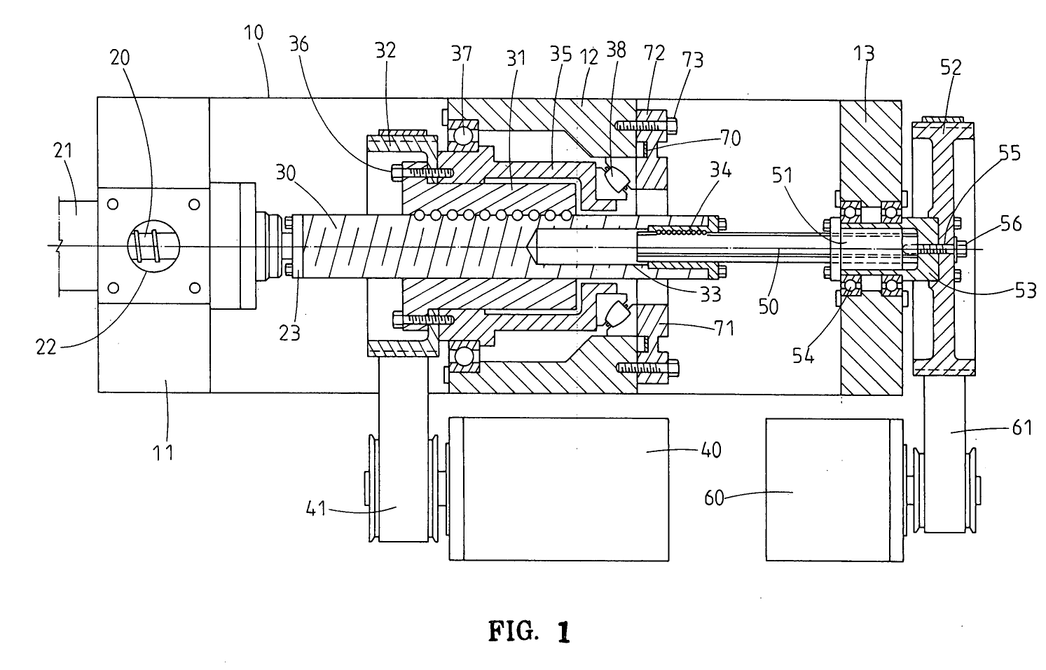

Referring to FIG. 1, an injection drive mechanism for a servo injection molding machine in accordance with the present invention generally includes a base 10 with a barrel seat 11, an injection seat 12, and a feeding seat 13 mounted thereon. An injection motor 40 (e.g., a servomotor) is mounted to an underside of the base 10 for driving a ball screw 30. Also mounted to the underside of the base 10 is a metering motor 60 (e.g., a servomotor) for driving a spline shaft 50.

Still referring to FIG. 1, a barrel 21 is mounted to the barrel seat 11. The barrel 21 includes an injection screw 20 extending longitudinally therethrough. A feeding inlet 22 is defined in a top side of the injection seat 11 for supplying plastic material to the injection screw 20. Mounted to the injection seat 12 is the ball screw 30 that has an axis coincident with that of the injection screw 20. An end (left one in FIG. 1) of the ball screw 30 is connected to an end of the injection screw 20 by a fastening member 23. The other end of the ball screw 30 includes an axial receptacle 33. A spline nut 34 is mounted in the axial receptacle 33 for slidingly coupling with an end of the spline shaft 50 that is mounted on the feeding seat 13 and that has a rotational axis coincident with that of the ball screw 30. Thus, the injection screw 20, the ball screw, 30, and the spline shaft 50 are mounted along the same axis.

In the illustrated embodiment, a ball nut 31 is mounted around the ball screw 30. A pulley 41 is fixed by bolts 36 to an end of the ball nut 31. The pulley 41 is driven by the injection motor 40 via a timing belt 41. Thus, the ball screw 30 is moved along the axial direction. A sleeve 35 is mounted around the ball nut 31. A deep groove bearing 37 is mounted between an end of the injection seat 12 and an end of the sleeve 35. A thrust bearing 38 is mounted between the other end of the injection seat 12 and the other end of the sleeve 35. Thus, the ball nut 31 rotates on site.

In the illustrated embodiment, a pressure sensor 70 is mounted to the injection seat 12. The pressure sensor 70 includes an inner ring 71 and an outer ring 72 that is integrally formed with the inner ring 71. The outer ring 72 is fixed by bolts 73 to an end face of the other end of the injection seat 12, and the inner ring 71 abuts against the thrust bearing 38 for detecting pressure fed back by the plastic material in the barrel 21.

A pulley 52 is fixed to a sleeve 53, which, in turn, is fixed to the other end of the spline shaft 50. The pulley 52 is driven by the metering motor 60 via transmission by a timing belt 61. Thus, the spline shaft 50 can be driven by the metering motor 60. Two deep groove bearings 54 are mounted between the sleeve 53 and the feeding seat 13, allowing the spline shaft 50 to rotate on site.

In the illustrated embodiment, a spline nut 51 is mounted between the other end of the spline shaft 50 and the sleeve 53. A bolt 56 is extended through a central hole 55 of the pulley 52 and a central hole (not labeled) in an end face (not labeled) of the sleeve 53 into the spline shaft 50. Thus, the spline shaft 50 can only rotate about the axis. Namely, the spline shaft 50 cannot move rectilinearly along the axis.

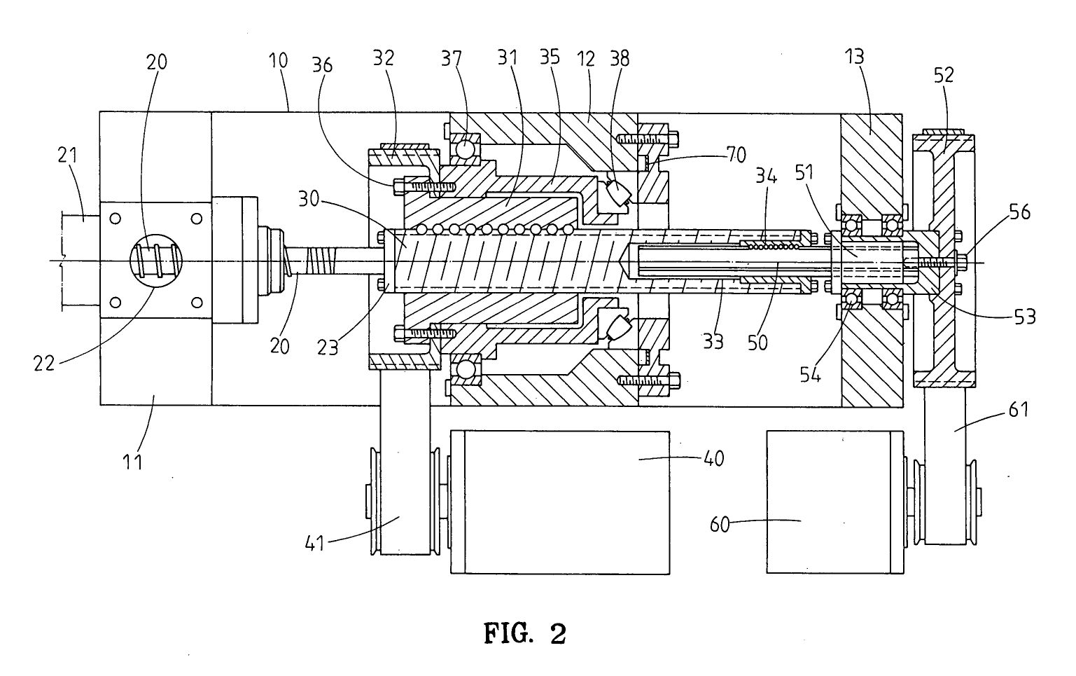

FIGS. 1 and 2 illustrate two operation examples of the present invention. When performing normal speed injection, the injection motor 40 rotates in a direction (e.g., clockwise) to drive the ball but 31 to turn, causing forward movement of the ball screw 30 (FIG. 1). The injection screw 20 injects molten plastic into a mold cavity (not shown) at normal speed. On the other hand, when the injection motor 40 rotates in a reverse direction (counterclockwise), the injection screw 20 is moved backward, as shown in FIG. 2. It is noted that the spline shaft 50 rotates on site without moving rectilinearly along the axis with the ball screw 30. The energy required for driving the ball screw 30 is less than that required in the conventional design. The energy is saved and the movement precision is improved.

When performing high-speed injection, the metering motor 60 rotates in a reverse direction (counterclockwise) while the injection motor 40 rotating in the clockwise direction. The ball screw 30 rotates in the reverse direction and thus moves forward. Meanwhile, the ball nut 31 rotates in a direction opposite to that of the ball screw 30. As a result, the ball screw 30 and the ball nut 31 rotate in opposite directions to speed up locking or release such that the injection screw 20 injects molten plastic material into the mold cavity at high speed.

After injection, the speed of the injection motor 40 is reduced. At last, supply of electricity continues and the injection motor 40 does not rotate. This maintains torque without operation such that pressure maintaining is achieved in the mold cavity.

When the injection motor 40 does not operate, operation of the metering motor 60 is sufficient to melt the plastic material.

When the injection motor 40 rotates at low speed in the reverse direction, the ball screw 30 is moved backward slowly. At this time, the metering motor 60 keeps on rotating for feeding, the injection screw 20 is moved backward slowly to achieve the required backpressure effect.

The injection motor 40 and the metering motor 60 may rotate in the same direction to increase the injection speed or rotate in opposite directions to reduce the injection speed. Further, the injection motor 40 and the metering motor 60 may rotate at the same speed or different speeds to achieve control of various speeds.

Although a specific embodiment has been illustrated and described, numerous modifications and variations are still possible without departing from the essence of the invention. The scope of the invention is limited by the accompanying claims.

What is claimed is:

1. An injection drive mechanism for a servo injection molding machine, comprising:
a base having a barrel seat, an injection seat, and a feeding seat mounted thereon, the base including a feeding inlet;
a barrel mounted to the barrel seat;
an injection screw rotatably extending through the barrel, the feeding inlet being adapted to allow feeding of plastic material to the injection screw;
a ball screw mounted to the injection seat, the ball screw including a first end that is connected with the injection screw and a second end having an axial receptacle, the ball screw including an axis that is coincident with that of the injection screw;
a spline nut mounted in the axial receptacle of the ball screw;
a spline shaft rotatably supported by the feeding seat, the spline shaft having an axis coincident with that of the ball screw, the spline shaft including an end coupled with the spline nut such that the spline shaft and the ball screw rotate jointly about the axis and that the spline shaft is not driven to move rectilinearly along the axis when the ball screw moves rectilinearly along the axis;
an injection motor for driving the ball screw to move relative to the spline shaft along the axis; and
a metering motor for driving the spline shaft to rotate on site.

2. The injection drive mechanism for a servo injection molding machine as claimed in claim 1, with a ball nut being mounted around the ball screw, with a sleeve securely mounted around the ball nut, with a deep groove bearing and a thrust bearing being mounted between the sleeve and the injection seat.

3. The injection drive mechanism for a servo injection molding machine as claimed in claim 2, further comprising a pressure sensor mounted to the injection seat and adjacent to the thrust bearing.

4. The injection drive mechanism for a servo injection molding machine as claimed in claim 3, with the pressure sensor including an inner and an outer ring that is integrally formed with the inner ring, the outer ring being fixed to the injection seat, the inner ring abutting against the thrust bearing for detecting pressure fed back by plastic material in the barrel.

5. The injection drive mechanism for a servo injection molding machine as claimed in claim 1, further comprising a sleeve fixed to another end of the spline shaft, two deep groove bearings being mounted between the feeding seat and the sleeve fixed to the spline shaft.

6. The injection drive mechanism for a servo injection molding machine as claimed in claim 5, further comprising a pulley fixed to the sleeve to turn therewith, the pulley being driven by the metering motor.

7. The injection drive mechanism for a servo injection molding machine as claimed in claim 6, further comprising a spline nut mounted between said another end of the spline shaft and the sleeve.

8. The injection drive mechanism for a servo injection molding machine as claimed in claim 6, with the pulley including a central hole, with the sleeve including a central hole in an end face thereof, further including a bolt extending through the central hole of the pulley and the central hole of the sleeve into the spline shaft.
